(19) United States
(12) Patent Application Publication
(10) Pub. No.: US 2025/0162045 A1
(43) Pub. Date: May 22, 2025

(54) QUICK CHANGE HOLE SAW MANDREL

(71) Applicant: BORDO INTERNATIONAL PTY. LTD., Scoresby (AU)

(72) Inventors: Iain BROWN, Scoresby (AU); Simon ANDRESEN, Mitcham (AU)

(21) Appl. No.: 18/841,384

(22) PCT Filed: Feb. 24, 2023
(86) PCT No.: PCT/AU2023/050126

§ 371 Date: Aug. 25, 2024

(30) Foreign Application Priority Data
Feb. 25, 2022 (AU) 2022900456

(51) Int. Cl. B23B 51/04

(52) U.S. Cl. CPC B23B 51/0473

(57) ABSTRACT

Quick-change hole saw mandrel (10) for a hole saw (18); includes drive shank (14) extending along a central axis (C); and mounting end (16) detachable connected to mounting aperture (26) of hole saw (18) and including drive pin (30) for engagement with drive pin aperture (28) of the hole saw (18). The mandrel (10) includes a gripping arrangement (32) insertable through the mounting aperture (26) for gripping the hole saw base (20). In a normally expanded configuration the gripping arrangement (32) grips the base (20). The gripping arrangement is selectively movable to a contracted configuration in which it can be inserted into or removed from the mounting aperture (26). A pilot bit lock selector (44) for selecting between an unlocked mode permitting quick removal and quick insertion of the pilot bit (12) and a locked mode in which the pilot bit (12) is locked against removal.

### PRIORITY CROSS-REFERENCE

This application claims priority to Australian provisional patent application AU 2022900456 filed 25 Feb. 2022, the entire contents of which is hereby incorporated by reference.

### TECHNICAL FIELD

The invention relates to a hole saw mandrel, also known as a hole saw arbor, for mounting a hole saw to a rotary tool such as a power drill. The invention particularly relates to a detachable hole saw mandrel which allows for the hole saw to be selectively detached from the mandrel and interchanged with a different hole saw. More particularly, the invention relates to a quick-change hole saw mandrel which expedites the process of changing hole saws on the hole saw mandrel.

### BACKGROUND OF INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Hole saws, also known as hole cutters, are annular saw blades for cutting circular holes in materials. Hole saws are typically cup-shaped with a base and an annular wall extending from the base with a toothed cutting edge. Hole saws are connectable to a rotary tool such as a power drill which drives rotation of the hole saw whilst pressed against a workpiece in which a hole is required.

The connection between the hole saw and the drill is provided by a hole saw mandrel (also known as an arbor) which includes a drive end for coupling with the rotary tool and a mounting end opposite to the drive end to which the hole saw is mounted. The drive end of the mandrel typically comprises a drive shaft, also known as a drive shank, engageable with the chuck of the power drill.

One variety of hole saw mandrels is the ‘fixed’ hole saw mandrel in which the hole saw is permanently mounted to the mandrel and requires the mandrel to be removed from the drill in order to change hole saws. Another variety are detachable hole saw mandrels which involve a detachable mounting between the hole saw and the mandrel and thus enabling the hole saw to be interchanged without removing the mandrel from the drill.

Detachable hole saw mandrels include a mounting end configured for detachable connection with a central mounting aperture in the hole saw base and sometimes include one or more drive pins for receipt in one or more drive pin apertures in the hole saw base. The mounting end is also configured for engaging with a central drill bit (known as a pilot bit or centre bit) which extends centrally through the hole saw. The pilot bit protrudes beyond the cutting edge of the hole saw and is drilled into the workpiece at the centre of the desired hole to be cut in order to stabilise and maintain the hole saw cutting edge at the desired position on the workpiece.

The detachable connection between the mounting end and the hole saw is most commonly provided via a threaded connection between a threaded portion of the mounting end and a lock nut on an underside of the hole saw base. A drawback with this type of mandrel is that interchanging hole saws is time consuming due to the requirement of loosening and re-tightening the lock nut.

To expedite the process of changing hole saws, quick-change hole saw mandrels have been developed. A common quick-change mandrel system requires a quick-change adapter to be attached to each hole saw in order to provide quick-change functionality. One such example is provided in U.S. Pat. No. 7,112,016. These systems require a user to purchase and fit quick change adapters to each of their hole saws which adds cost and time. Furthermore, it is sometimes necessary to remove the quick-change adapters from the hole saws after use to allow storage of the hole saws in their corresponding storage box. This adds further time and inconvenience to the system.

Other quick-change hole saw mandrels have been developed which avoid the need for adapters and one such mandrel is described in U.S. Pat. No. 10,105,764. However, this and similar systems require proprietary hole saws of a particular configuration that is compatible with the mounting end of the mandrel. These mandrels are not configured for use with conventional hole saws having a circular central mounting aperture and, instead, require a user to purchase new proprietary hole saws specifically designed for use with the corresponding quick-change mandrel.

### SUMMARY OF INVENTION

In view of the above, it is desirable to provide a new quick-change hole saw mandrel with improved hole saw compatibility and/or streamlined functionality and/or which provides an alternative choice for users.

Before turning to a summary of the invention, it is useful to provide an explanation of some of the terms that will be used to define the spatial relationship of various parts thereof. In this respect, spatial references throughout this specification will generally be based upon a hole saw mandrel which has a mounting end for mounting a hole saw and an opposite drive end for coupling with a rotary tool. For convenience, the mounting end will be considered a ‘top’ of the mandrel and the drive end will be considered a ‘bottom’ of the mandrel. In this context, terms such as “upper”, “upwardly”, “topside”, “top” and the like will be understood as referring to components or portions thereof which are toward the mounting end of the mandrel. Equivalently, terms such as “lower”, “downwardly”, “underside”, “bottom” and the like will be understood as referring to components or portions thereof which are toward the drive end of the mandrel. Furthermore, it will be understood that the mandrel has a central axis and so terms such as “radially” refer to a dimension perpendicular with the central axis. Terms such as “inwardly” and “outwardly” will be understood as meaning toward or away from the central axis respectively.

According to an aspect of the present invention there is provided a quick-change hole saw mandrel for a hole saw having a base with a central circular mounting aperture and a drive pin aperture, the mandrel including: a drive shank extending along a central axis of the mandrel for releasable engagement with a rotary tool; a mounting end opposite to the drive shank configured for detachable connection with the mounting aperture of the hole saw and including a drive pin for engagement with the drive pin aperture of the hole saw; a gripping arrangement at the mounting end which is insertable through the mounting aperture for gripping the hole saw base, the gripping arrangement having a normally expanded configuration in which the gripping arrangement grips the base against movement along the central axis and selectively movable to a contracted configuration in which the gripping arrangement can be inserted into or removed from the mounting aperture; and a quick-release pilot bit connection arrangement for coupling a quick-release pilot bit to the mandrel, the connection arrangement configured for receiving the pilot bit through a pilot bit aperture extending centrally through the gripping arrangement and the connection arrangement including a pilot bit lock selector for selecting between an unlocked mode permitting quick removal and quick insertion of the pilot bit and a locked mode in which the pilot bit is locked against removal from the connection arrangement.

The present invention advantageously provides a hole saw mandrel that is not limited to use with proprietary hole saws but rather is configured for use with conventional hole saws having a central circular mounting aperture and a drive pin aperture. Furthermore, in addition to providing quick-change hole saw functionality, the mandrel of the present invention also includes a quick-release pilot bit connection arrangement which provides quick-change pilot bit functionality.

The quick-change mandrel according to the invention advantageously allows for tool-less interchange of the hole saw and tool-less interchange of the pilot bit. A user is therefore able to remove and replace both the hole saw and the pilot bit without requiring tools such as Allen keys or spanners which encumber the interchange process on previous mandrel systems. In a form of the invention, the mandrel is configured to allow interchange of these components using only the user's hands.

The invention may be particularly applicable for use with larger hole saws which include drive pin apertures. Typically, hole saws of the type driven by drive pins are of approximately 32 mm diameter or larger. The present invention may also be suitable for use with smaller hole saws having no drive pin apertures with the use of an adapter. According to a form of the invention the hole saw mandrel is configured for a hole saw having a pair of drive pin apertures and the mounting end of the mandrel includes a pair of drive pins configured for engagement with the pair of drive pin apertures. The position of the drive pins relative to the gripping arrangement may correspond with the position of the drive pin apertures relative to the mounting aperture on the hole saw. For example, the mandrel may be configured for use with a hole saw having at least two drive pin apertures located on opposite sides of the mounting aperture and in this case the drive pins of the mandrel may be located on opposite sides of the gripping arrangement so as to engage with the drive pin apertures when the gripping arrangement is engaged with the mounting aperture.

The pilot bit lock selector advantageously allows a user to quickly unlock the pilot bit for removal or replacement such as when a bit becomes blunt or when a different type of bit is required to drill through a different material. In use, the changing of hole saw size can often necessitate the changing of the pilot bit. The invention integrates quick-change hole saw functionality with quick-change pilot bit functionality to significantly improve useability. This is particularly advantageous as compared to some existing systems which allow for quick hole saw interchange but involve cumbersome pilot bit change processes such as loosening grub screws or other fasteners and which also require external tools such as Allen keys to change the pilot bit.

The lock selector may be provided in a variety of forms which enable manual selection between locked and unlocked modes. According to a particular form of the invention, the lock selector comprises a locking collar rotatable about the central axis between an unlocked position corresponding to the unlocked mode and a locked position corresponding to the locked mode. The locking collar may include a circumferential gripping formation such as notching, knurling, ridges, protrusions, recesses, fluting or a combination thereof in order to enhance a user's digital grip of the locking collar.

In a particular form of the invention, the locking collar is rotatable approximately 90° about the central axis between the unlocked position and locked positions. According to a form of the invention the mandrel includes indicia to indicate whether the locking collar is in the locked or unlocked positions. The indicia may comprise locked and unlocked symbols or text on a body of the mandrel and an indicating protrusion on the locking collar. In use, the locking collar is rotatable about the central axis relative to the indicia such that the indicating protrusion can be rotated between the locked and unlocked indica.

The pilot bit connection arrangement may be configured for use with a ball-detent hex shank pilot bit of the conventional quick-release drill bit variety. In a form of the invention, the pilot bit connection arrangement includes a ball detent connection arrangement. The ball detent connection arrangement may include a ball assembly including a ball locatable in the ball detent of the pilot bit shank for locking the pilot bit shank against removal. It will be appreciated that a ball-detent hex shank is the conventional form of quick-release drill bit and therefore according to this embodiment the mandrel is advantageously compatible for use with conventional quick-release pilot bits and is not limited to use with proprietary pilot bits. For example, in a form of the invention, the mandrel is configured to accept conventional ¼ inch hex shank drill bits.

In a form of the invention, the locking collar includes an internal abutment which, in the locked position, retains the ball in the ball detent of the hex shank. In the locked position, the internal abutment may align with and overlie the ball to thereby prevent the ball from movement away from the ball detent of the hex shank. That is, the internal abutment may retain the ball in the ball detent of the pilot bit and thereby prevent removal of the pilot bit. The internal abutment may comprise an inwardly-extending radial protrusion located on an interior surface of the locking collar. The locking collar may be configured such that, in the unlocked position when the abutment is not aligned with the ball, a recess is formed between the ball and the locking collar such that the ball is permitted to move into the recess and out of the ball detent thereby enabling release of the pilot bit.

According to an embodiment of the invention, the mandrel includes an adjustable spacer at the mounting end configured to facilitate use of the mandrel with hole saws of different base thicknesses. Hole saws having different diameter or originating from different manufacturers may have bases of differing thickness. Some existing quick-change hole saw mandrels are designed for hole saws of a particular base thickness (typically the base thickness of hole saws produced by the manufacturer of that particular mandrel) and are incompatible (or functionality is compromised) with hole saws of different base thickness. For these mandrels, a hole saw of different base thickness may either be totally incompatible or may be connectable but with an unsecure coupling that produces undesirable vibration during use.

The adjustable spacer of the present invention advantageously addresses this problem by enabling the spacer to be positionally adjusted so as to accommodate hole saws of different base thicknesses and thereby providing compatibility with a larger range of hole saws. According to a particular embodiment, the spacer is movable along the central axis relative to the gripping arrangement to accommodate various hole saw base thicknesses. The spacer may be configured to contact an underside of the hole saw base.

In a form of the invention, the spacer comprises an annular plate with a circumferential thread engaged with an internal thread of a spacer-adjustment collar. Rotation of the spacer-adjustment collar causes positional adjustment of the spacer along the central axis. In use with a hole saw of relatively small base thickness, the spacer may be moved in a direction toward the hole saw (i.e. away from the drive shank) and into contact with the underside of the hole saw base. In this example, the spacer is adjusted so as to protrude outward from the mounting end and beyond the spacer-adjustment collar. In the event that the thin-based hole saw was interchanged with a thicker-based hole saw, the spacer can be retracted into the mounting end as required to accommodate the thicker hole saw base.

In a form of the invention, the spacer may be configured to clamp the hole saw base between the spacer and a portion of gripping arrangement. Said portion of the gripping arrangement may comprise a lip or catch engaged with a top surface (i.e. a topside) of the hole saw base (the surface of the hole saw base inside the annular wall of the hole saw). The hole saw base may thereby be clamped between the adjustable spacer on its underside and the gripping arrangement lip or catch on its topside.

As noted, the gripping arrangement is movable from a normally expanded configuration to a contracted configuration which permits insertion or removal of the gripping arrangement from the mounting aperture. In a form of the invention, the mandrel includes a sliding collar which is manually movable along the central axis for selectively moving the gripping arrangement to the contracted configuration. The sliding collar may include one or more gripping portions such as a protrusion, detent, recess, hatched portion or any other configuration facilitating engagement by a user's fingers or hand when sliding the collar.

In a form of the invention the sliding collar is slidable toward the drive shank for actuating movement of the gripping arrangement to the contracted configuration. In a form of the invention, releasing the sliding collar when slid toward the drive shank causes the collar to return to its normal position which corresponds with the expanded configuration. The sliding collar may be urged towards its normal position by an internal biasing arrangement.

According to a form of the invention, the gripping arrangement includes a pair of grippers, each gripper including a distal end protruding from the mounting end and having a catch for engaging the base of the hole saw. In a form of the invention, the pair of grippers are spaced apart from each other in the expanded configuration and moved toward each other in the contracted configuration. The grippers may be movable relative to the central axis in a direction perpendicular to the central axis. For example, the grippers may be radially movable with respect to the central axis.

In a form of the invention, the gripping arrangement may comprise more than two grippers such as three or four or even more grippers spaced equidistantly around the central axis and each configured to move radially inward toward the central axis toward a contracted configuration.

In a form of the invention, each catch is generally semi-circular and, in the contracted configuration, the pair of catches forms an approximately circular configuration. The circular configuration is therefore suitable for insertion through the circular mounting aperture of the hole saw. Each of the catches may have an arc-shaped configuration such that in the expanded configuration, the arc-shaped catches overlap an arc-shaped portion of the hole saw base topside. This configuration is advantageous in that it increases or maximises the contact area between the circular mounting aperture and the gripping arrangement.

This is in contrast to some existing quick change mandrel systems which contact the hole saw aperture at discrete gripping points. Compared to previous configurations such as these, the gripping arrangement of the present invention may have an increased contact area via a semi-circular (e.g. arc-shaped) catch configuration which provides a more secure connection between the gripping arrangement and the hole saw. In other forms of the invention, the catches may have another curvilinear configuration such as a semi-oval or crescent configuration or, alternatively, may have a non-curvilinear configuration such as a polygonal configuration.

In a form of the invention, when in the contracted configuration, the catches of the gripping arrangement form a circular configuration having a diameter smaller than the diameter of the hole saw mounting aperture to enable insertion and removal from the mounting aperture. In a form of the invention, when in the expanded configuration, the catches of the gripping arrangement form an enlarged configuration having a diameter larger than the diameter of the hole saw mounting aperture to prevent or resist withdrawal of the gripping arrangement from the mounting aperture. In a form of the invention, the gripping arrangement is configured for use with hole saws of 32 mm diameter or larger which are typically provided with a conventional ⅝-inch UNF threaded mounting aperture. The gripping arrangement may therefore have catches of slightly less than ⅝-inch width when in the contracted configuration.

According to a form of the invention, in the expanded configuration the gripper catches are spaced apart from one another so as to engage and grip the hole saw base. The pair of catches may be configured to contact a topside of the hole saw base and to clamp the hole saw base between the mounting end and the catches. Each catch may comprise a lip extending radially outward from the respective gripper. Each radially extending lip may form a recess below the lip which is configured to receive an edge of the mounting aperture. In a form of the invention, an edge of a mounting aperture is received within a recess formed between the lip and the adjustable spacer.

According to a form of the invention, the gripping arrangement includes a biasing arrangement urging the gripping arrangement toward the expanded configuration. The biasing arrangement may comprise any suitable biasing element(s) such as resiliently flexible rubber or steel, a magnetic arrangement or a spring arrangement or a combination thereof. In a particular form of the invention, the biasing arrangement comprises a pair of helical springs positioned between the pair of grippers. The pair of helical springs are in a normally expanded position in which the pair of grippers are spaced apart from each other corresponding to the expanded configuration of the gripping arrangement.

In a form of the invention, the grippers are urged together by an applied force which overcomes the bias of the helical springs and moves the grippers together which corresponds to the contracted configuration of the gripping arrangement.

The applied force to the grippers may be provided from user-generated movement of the sliding collar along the central axis. According to a form of the invention, the sliding collar is in contact with a portion of the grippers such that movement of the sliding collar along the central axis urges the grippers toward the contracted configuration. For example, each gripper may include an outwardly-facing ramped surface in contact with an inwardly-facing corresponding ramped surface on the sliding collar and wherein movement of the inwardly-facing ramped surface of the sliding collar toward the drive shank urges the outwardly-facing ramped surfaces of the grippers toward the central axis and into the contracted configuration.

The outwardly-facing ramped surfaces of the grippers and the inwardly-facing ramped surface of the sliding collar may have an equivalent inclination relative to the central axis. In a form of the invention, both the outwardly-facing ramped surfaces and the inwardly-facing ramped surfaces are inclined at between 20°-40° to the central axis. In a particular form of the invention the inclination is between 25°-35°. In a particular form of the invention the inclination is approximately 30° with respect to the central axis. In a form of the invention, the direction of inclination is such that the ramped surfaces taper toward the mounting end of the mandrel.

The mandrel may further include an angle plate having a ramped surface in contact with corresponding ramped surfaces on an underside of the grippers and wherein contact between the ramped surface on the underside of each gripper and the ramped surface of the angle plate promotes movement of the grippers toward the contracted configuration. In a form of the invention the angle plate is saddle shaped with a pair of opposite ramped surfaces. The ramped surfaces of the angle plate may be located on top of the angle plate, i.e. on a side of the angle plate orientated toward the mounting end of the mandrel. The angle plate may have a symmetrical configuration about the central axis of the mandrel with the ramped surfaces angled from opposite sides of the central axis such that each ramped surface is equivalently angled from the central axis but are not parallel with one another.

In a form of the invention, the ramped surfaces of the angle plate may be angled with respect to the central axis by an angle between 80°-90°, more particularly between 82°-88° and in a particular form of the invention approximately 85°. Each ramped surface may be angled at 85° from an opposite side of the central axis such that the interior angle between the ramped surfaces is approximately 170°. The angle plate may therefore have a relatively wide V-shape or saddle-shaped configuration which is configured to promote sliding movement of the grippers toward the central axis when the underside ramped surfaces of the grippers are urged against the angle plate ramped surfaces under load applied by the sliding collar.

In a form of the invention, the underside ramped surfaces of each gripper are parallel with one of the ramped surfaces of the angle plate. The underside ramped surfaces of each gripper may therefore be angled with respect to the central axis by an angle of between 80°-90°, more particularly between 82°-88° and in a particular form of the invention approximately 85°.

The above-discussed mandrel may form part of a hole saw assembly when combined with a hole saw and a pilot bit. In this regard, another aspect of the present invention provides a hole saw assembly including: a hole saw having a base and an annular wall extending from the base with a toothed cutting edge, the base including a central circular mounting aperture and at least one drive pin aperture; a quick-release pilot bit comprising a ball-detent hex shank drill bit; a quick change hole saw mandrel, including a drive shank extending along a central axis of the mandrel for releasable engagement with a rotary tool; a mounting end opposite to the drive shank detachably connected with the mounting aperture of the hole saw and including a drive pin in engagement with the drive pin aperture of the hole saw; a gripping arrangement at the mounting end which is inserted in the mounting aperture and gripping the hole saw base, the gripping arrangement having a normally expanded configuration in which the gripping arrangement grips the base against movement along the central axis and is selectively movable to a contracted configuration in which the gripping arrangement can be removed from the mounting aperture; and a quick-release pilot bit connection arrangement coupling the quick-release pilot bit to the mandrel, the pilot bit connection arrangement receiving the pilot bit through a pilot bit aperture extending centrally through the gripping arrangement and the pilot bit connection arrangement including a pilot bit lock selector for selecting between an unlocked mode permitting quick removal and quick insertion of the pilot bit and a locked mode in which the pilot bit is locked against removal from the connection arrangement.

### BRIEF DESCRIPTION OF DRAWINGS

In order that the invention may be more fully understood, some embodiments will now be described with reference to the figures in which:

FIG. 1 is a front perspective view of a hole saw mandrel according to an embodiment of the present invention and with a pilot bit coupled to the mandrel;

FIG. 2 is a perspective top view of a conventional hole saw having a central mounting aperture and drive pin apertures;

FIG. 2a is a perspective underside view of the hole saw of FIG. 2;

FIG. 3 is a perspective view of the hole saw of FIG. 2 detachably connected to the mandrel of FIG. 1;

FIG. 4 is a rear perspective view of the mandrel of FIG. 1;

FIG. 5 is an exploded view of the mandrel shown in FIG. 1;

FIG. 6 is a side view of the mandrel of FIG. 1;

FIG. 7 is a cross-sectional view of FIG. 6;

FIGS. 8 and 9 are side and top perspective views of a body portion of the mandrel of FIG. 1;

FIG. 10 is a perspective view of a base collar of the mandrel of FIG. 1;

FIG. 11 is a perspective view of a locking collar of the embodiment in FIG. 1;

FIGS. 12 and 13 are perspective and side sectional views of an angle plate of the mandrel of FIG. 1;

FIG. 14 is a perspective view of an adjustable spacer of the mandrel of FIG. 1;

FIG. 15 is a perspective view of a spacer-adjustable collar of the mandrel of FIG. 1;

FIGS. 16 and 17 are perspective and side sectional views of a sliding collar of the mandrel of FIG. 1;

FIGS. 18 and 19 are perspective and side sectional views of a gripper of the mandrel of FIG. 1;

FIGS. 20 and 21 are perspective and side sectional views of a top plate of the mandrel of FIG. 1;

FIG. 22 is a cross-sectional view of a hole saw assembly comprising the mandrel of FIG. 1 with a thick-based hole saw connected to the mandrel and a pilot bit coupled to the mandrel;

FIG. 23 is a cross-sectional view of a hole saw assembly comprising the mandrel of FIG. 21 with a thin-based hole saw connected to the mandrel and a pilot bit coupled to the mandrel;

FIG. 24 is a view of the hole saw assembly of FIG. 8 with a sliding collar retracted and a gripping arrangement moved to a contracted position; and

FIG. 25 is a cross-sectional view of a hole saw assembly according to an embodiment of the invention with the pilot bit decoupled and partially removed from the mandrel.

### DETAILED DESCRIPTION

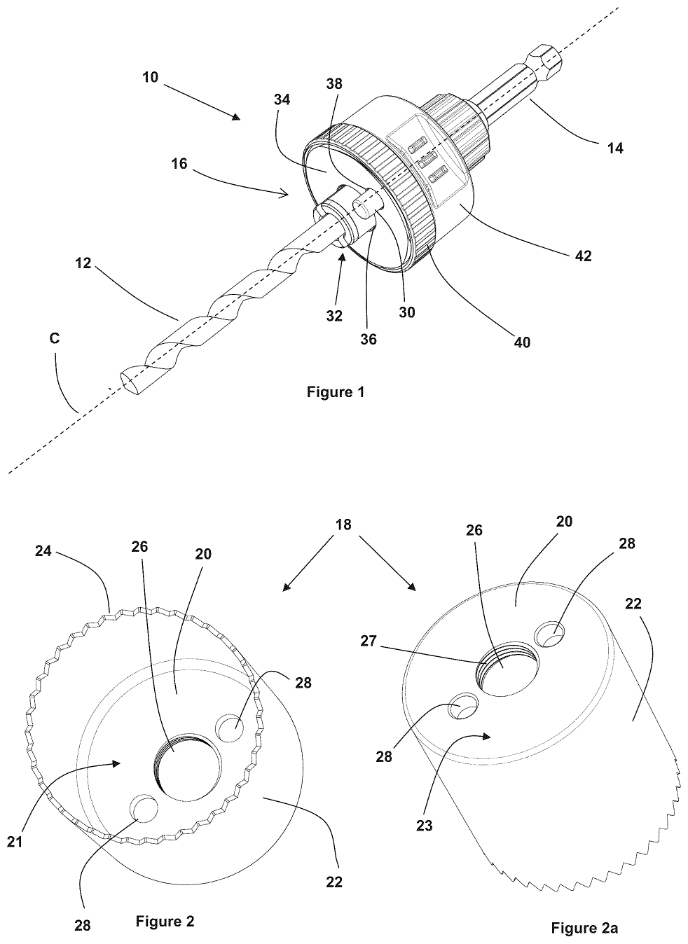

FIG. 1 illustrates an embodiment of a quick-change hole saw mandrel 10 according to the present invention. Mandrel 10 is coupled with a pilot bit 12. Mandrel 10 includes a drive shank 14 extending along a central axis C of the mandrel. The drive shank 14 has a conventional quick-release hex shank ball-detent configuration for engagement with a rotary tool such as a power drill.

Mandrel 10 includes a mounting end 16 configured for detachable connection with a hole saw 18 that is illustrated in FIGS. 2 and 2a. The hole saw 18 includes an annular base 20 and an annular wall 22 extending from the base 20 having a toothed cutting edge 24 for cutting a hole in a workpiece. The base 20 includes a central circular mounting aperture 26 and a pair of drive pin apertures 28 located on opposite sides of the mounting aperture 26. The hole saw base 20 includes a topside 21 visible and labelled in FIG. 2 and an underside 23 visible and labelled in FIG. 2a.

The configuration of hole saw 18 is considered a conventional hole saw design which is used by most manufacturers and is compatible for use with a variety of different hole saw mandrels and arbors. In this regard, the central mounting aperture 26 includes an internally threaded surface 27 for engaging with an externally threaded mount on conventional hole saw mandrels.

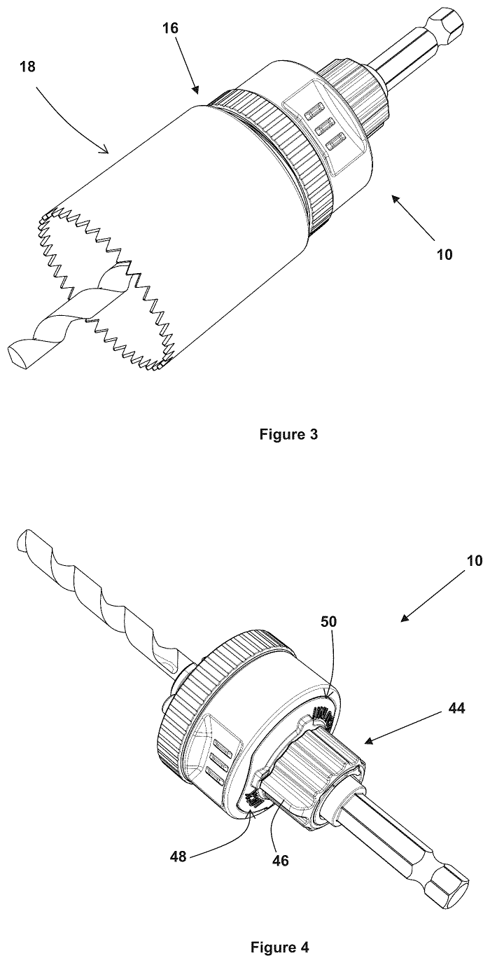

A pair of drive pins 30 (only one of which is visible in FIG. 1) are provided at the mounting end 16 of mandrel 10 for engagement with the corresponding drive pin apertures 28 in the hole saw 18. A gripping arrangement 32 is located at the mounting end 16 and which is insertable through the mounting aperture 26 of the hole saw 18. FIG. 3 illustrates the hole saw 18 detachable connected to the mounting end 16 of the mandrel 10. When the hole saw 18 is connected to mandrel 10 as shown in FIG. 3, it will be appreciated that the underside 23 of the hole saw base 18 is placed into contact with the mounting end 16 of the mandrel 10.

Still referring to FIG. 1, the mandrel 10 has a central axis C and which hereinafter will be referred to as a reference point for the location and movement of various components of the mandrel 10. As illustrated in FIG. 1, pilot bit 12 and drive shank 14 are approximately collinear with the central axis C.

The mounting end 16 further includes an adjustable spacer 34 having an annular disc profile and which is illustrated in isolation in FIG. 14. The adjustable spacer 34 includes a central opening 36 and a pair of drive pin openings 38 on opposite sides of the central opening 36. As shown in FIG. 1, the gripping arrangement 32 and pilot bit 12 extend through the central opening of the spacer 34. Similarly, the drive pins 30 extend through the drive pin openings 38 in the spacer 34.

The mandrel 10 further includes a spacer-adjustment collar 40 which is illustrated in isolation in FIG. 15. The collar 40 is rotatable about the central axis C and configured to allow positional adjustment of the spacer 34 along the central axis C. Referring to FIGS. 14 and 15, the annular wall 35 of the spacer 34 is externally threaded for engaging with a corresponding internally threaded surface 41 of the spacer-adjustment collar 40 illustrated in FIG. 15. The exterior of the spacer-adjustment collar 40 has a fluted configuration to facilitate gripping with a user's fingers. The spacer-adjustment collar 40 includes an annular shoulder 43 received by a corresponding shoulder groove 84 in the top plate 80 and which is best illustrated in FIG. 21.

Returning to FIG. 1, adjacent to the spacer-adjustment collar 40 is a sliding collar 42 configured to be manually slid by a user's hand along the central axis C in order to move the gripping arrangement 32 from an expanded configuration for gripping the hole saw 18 to a contracted configuration for allowing hole saw removal or interchange. The operation of the sliding collar 42 will subsequently be described in further detail.

Turning to FIG. 4 which provides a rear perspective of the mandrel 10, the mandrel 10 further includes a pilot bit lock selector comprising a locking collar 44 enabling a user to select between an unlocked mode permitting quick removal and quick insertion of the pilot bit 12 and a locked mode in which the pilot bit 12 is locked against removal. The locking collar 44 is rotatable about the central axis C between a locked position corresponding to the locked mode and an unlocked position corresponding to the unlocked mode.

The locking collar 44 includes an indicating protrusion comprising a raised rib 46 on its exterior surface which the user can rotate between locked indicia 48 and unlocked indicia 50 provided on a base collar 76 which will be discussed subsequently in further detail. In FIG. 4, the raised rib 46 is positioned at the locked indicia 48 which corresponds to the locked position indicating to the user that the pilot bit 12 is locked against removal.

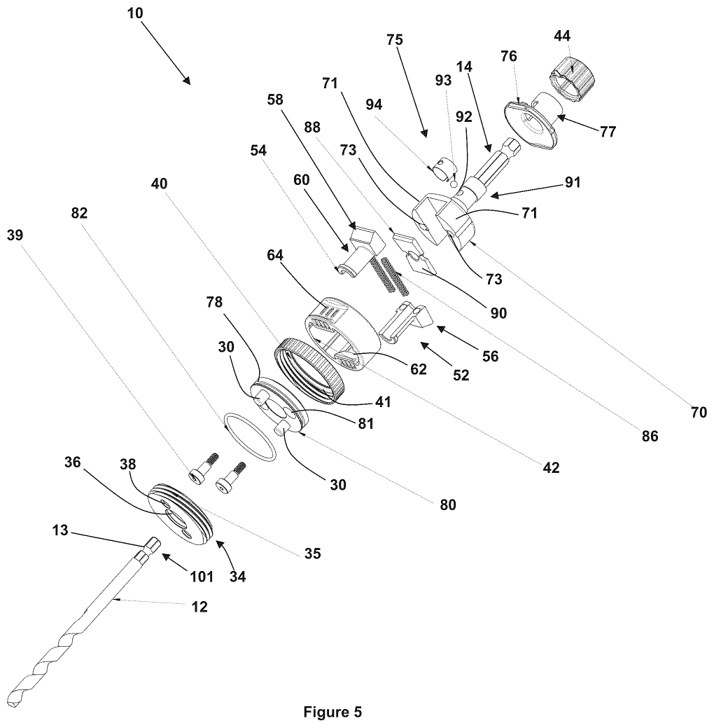

Turning to FIG. 5, an exploded view of the mandrel 10 is provided. The components of the exploded view will be described in sequence to inform subsequent discussion of the components.

Beginning at the bottom left of FIG. 5, is the hex shank quick-release pilot bit 12 which is received through the central opening 36 in the adjustable spacer 34. The pilot bit 12 includes a hexagonal base portion 101 that includes a ball detent 13. The pilot bit 12 will be recognised by a person skilled in the art as a conventional quick-release hex shank pilot bit of the type that is produced by most manufacturers and which is compatible with most quick-release drill bit chucks and connectors.

A pair of bolts 39 extend through corresponding openings 81 in a top plate 80 which includes the pair of drive pins 30 which extend through drive pin openings 38 in the spacer 34. An O-ring seal 82 locates in a corresponding groove 78 in the circumferential surface of top plate 80. The O-ring seal 82 is provided to limit leakage of grease or other lubricant which may be used to reduce friction on moving components of the mandrel 10. The top plate 80 is surrounded by the spacer-adjustment collar 40. An externally threaded annular wall 35 of the spacer 34 is located between the circumferential surface of the top plate 80 and the spacer-adjustment collar 40 which includes an internally threaded surface 41 engaged with the external thread of the annular wall 35.

Adjacent to the spacer-adjustment collar 40 is the sliding collar 42 which includes exterior indentures 64 facilitating manual gripping by the user. The sliding collar surrounds several components including part of the gripping arrangement which includes a pair of grippers 52 each having a base portion 56, a neck 60 and a lip 54. The base portion 56 of each gripper 52 includes an outwardly-facing ramped surface 58 which contacts corresponding inwardly-facing ramped surfaces 62 on the interior of the sliding collar 42. A pair of helical springs 86 are located between the grippers 52 which urge the grippers 52 to an expanded configuration in which the grippers 52 are spaced apart from one another. Adjacent to the gripper base portions 56 is an angled plate 88 with a pair of ramped surfaces 90 which contact an underside of the gripper base portions 58. The angled plate 88 seats on a mandrel body 70 having a pair of protrusions 71 each having an internally threaded bolt opening 73 for engaging with the bolts 39.

The mandrel 10 further includes a pilot bit connection arrangement which, in the illustrated embodiment is a ball detent connection arrangement 75. The ball detent connection arrangement 75 includes a stem 91 provided on the mandrel body 70 having a ball opening 92. The ball detent connection arrangement 75 further includes a ball 93 received in the ball opening 92 and a spring collar 94 for securing the ball 93 in the ball opening 92 to form a ball assembly. The drive shank 14 extends from the body stem 91. The body stem 91, and ball assembly is located within a base collar 76. The locking collar 44 surrounds a stem portion 77 of the base collar 76.

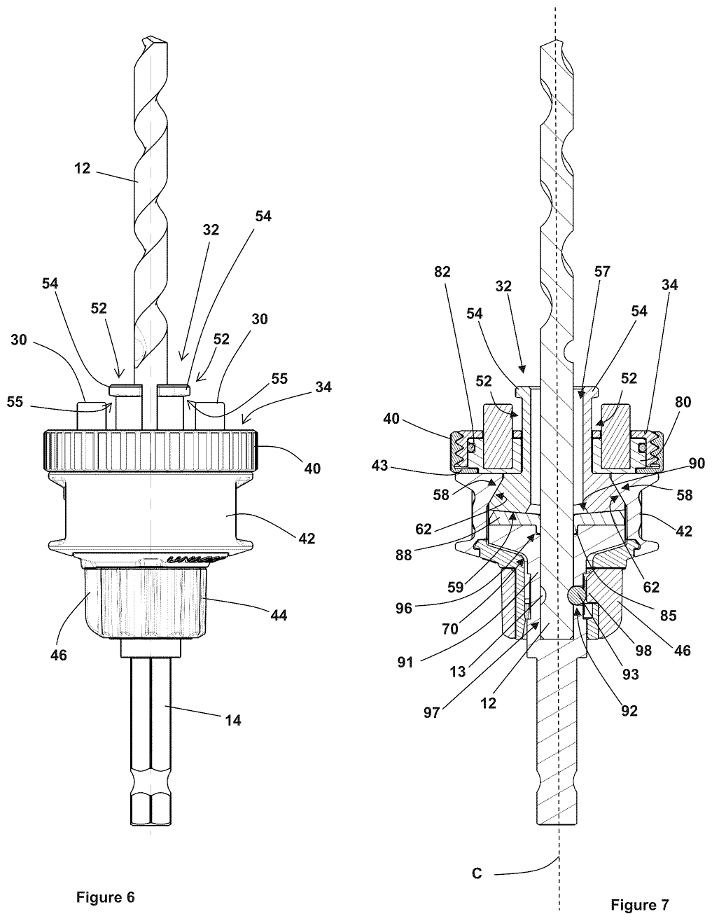

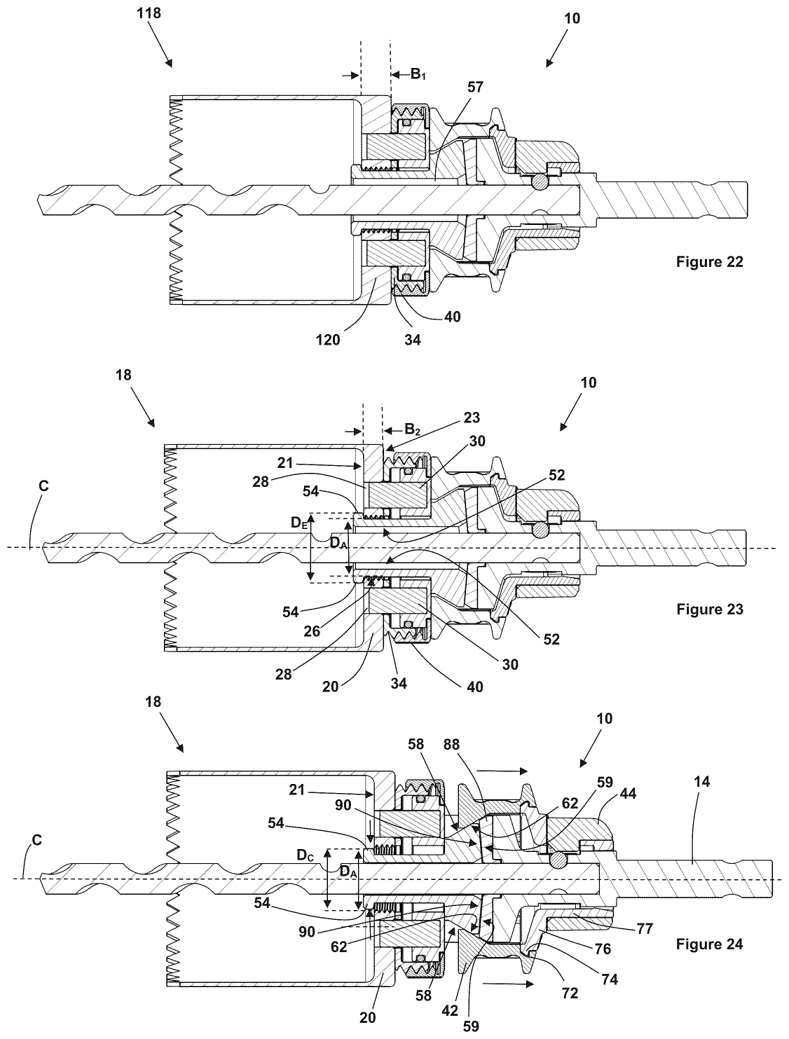

FIGS. 6 and 7 respectively provide side and side cross-sectional views of the mandrel 10. The gripping arrangement 32 comprises a pair of identical grippers 52 which are generally elongate in shape and arranged on opposite sides of the central axis C. Each gripper 52 includes a catch comprising a semi-circular lip 54 extending from a distal end of the gripper 52 in a direction radially outwardly with respect to the central axis C. Each lip 54 forms a recess 55 between the lip 54 and the spacer 34 which is configured to receive an edge of the mounting aperture 26. FIG. 7 also illustrates a pilot bit aperture 57 extending centrally through the gripping arrangement 32 and, in particular, extending between the grippers 52. The pilot bit aperture 57 (also labelled in FIG. 22) extends along the central axis C and receives the pilot bit 12 therethrough.

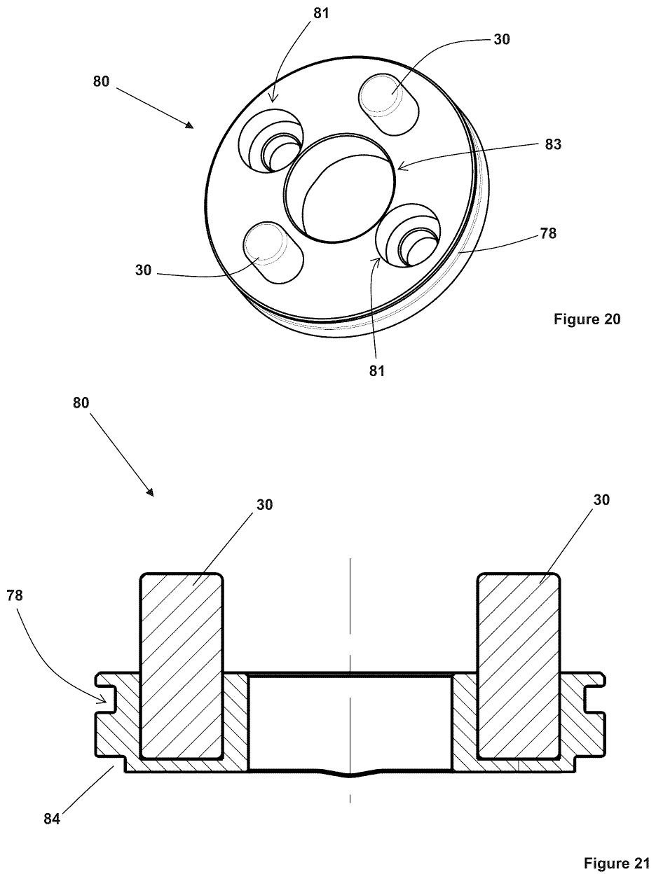

Turning to FIGS. 18 and 19, one of the grippers 52 is illustrated in isolation for convenience of description. The gripper 52 includes a base portion 56 which includes a ramped surface 58 that is inclined with respect to the central axis C. The ramped surface 58 of each gripper 52 is orientated radially outwardly with respect to the central axis C and is therefore termed an outwardly-facing ramped surface 58. The gripper 52 further includes a semi-circular neck 60 extending from the base portion 56 in an orientation parallel with the central axis C. Atop the neck 60 is the semi-circular lip 54 which extends radially outwardly with respect to central axis C.

As shown in FIG. 19, the outwardly-facing ramped surface 58 is inclined at approximately 30° with respect to the central axis C. An underside of the base portion 56 of each gripper 52 comprises a underside ramped surface 59 which is angled at 95° from the central axis C (i.e. 5° from an axis perpendicular to the central axis C).

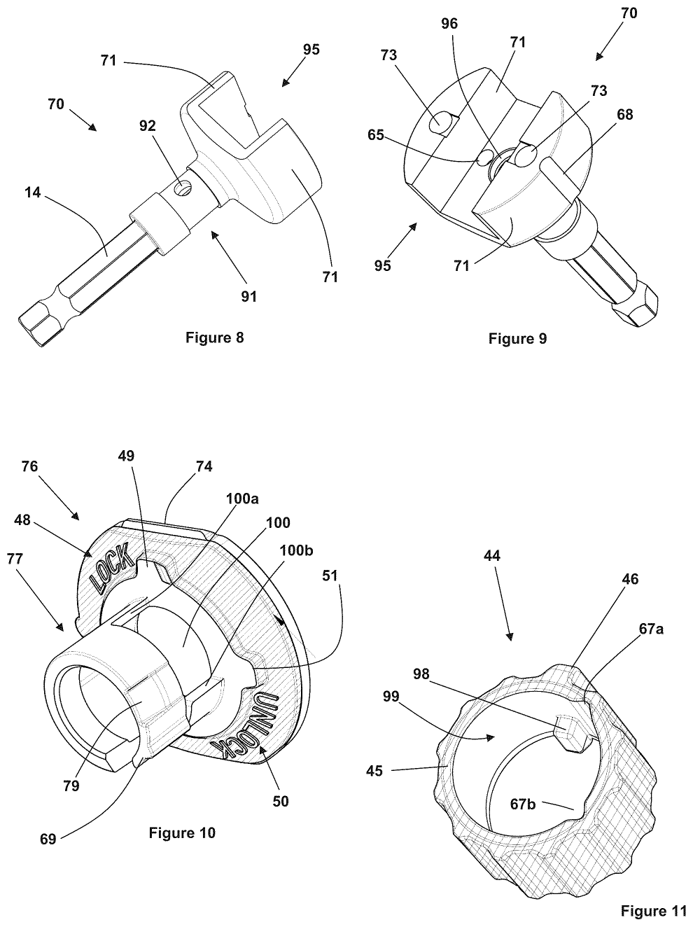

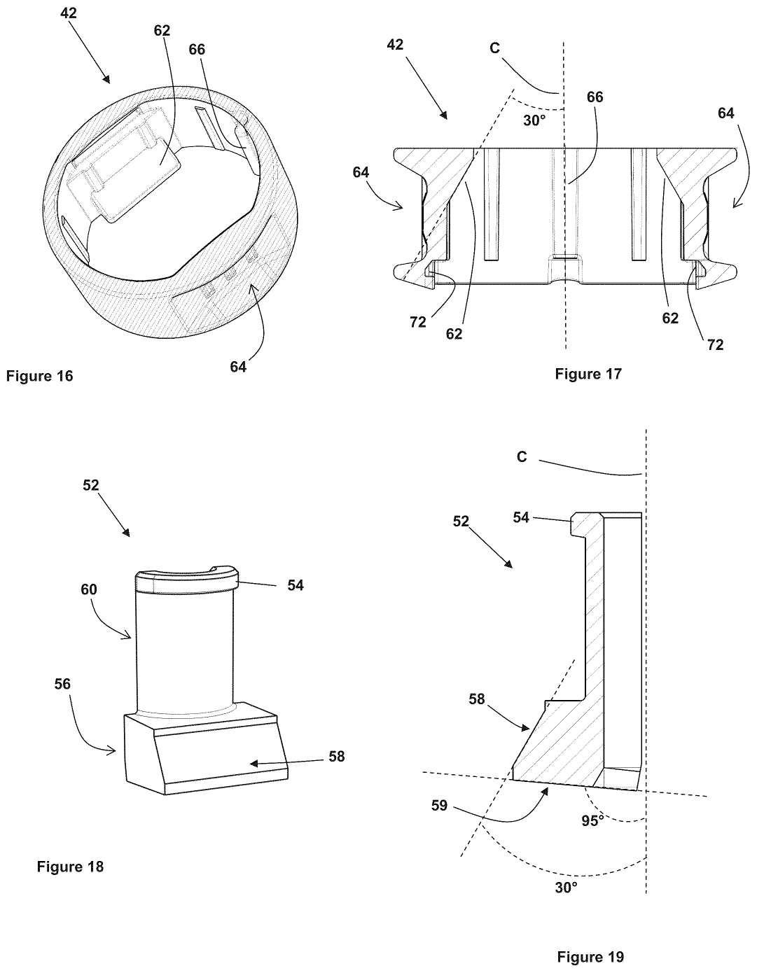

Returning to FIG. 7, the outwardly-facing ramped surfaces 58 of the grippers 52 contact corresponding inwardly-facing ramped surfaces 62 on an interior the sliding collar 42. Turning to FIGS. 16 and 17, the sliding collar 42 is illustrated in isolation for convenience of description. The sliding collar 42 has a generally annular configuration with an exterior having a pair of indentures 64 on opposite sides of the collar 42 to facilitate gripping of the collar by a user's fingers. An interior of the sliding collar 42 includes a pair of opposing ribs 66 which are configured for receipt and sliding engagement with a pair of corresponding grooves 68 in an outwardly-facing surface of the mandrel body 70 which is illustrated in FIGS. 8 and 9.

Still referring to FIGS. 16 and 17, the interior of the sliding collar 42 also includes a pair of opposing grooves 72 which receive a pair of corresponding outwardly-facing connection flanges 74 on the base collar 76 and which are illustrated in FIG. 10. As best shown in FIG. 17, the interior of the sliding collar 42 includes the pair of inwardly-facing ramped surfaces 62 on opposite sides of the collar interior and which face generally inwardly with respect to the central axis C. As shown in FIG. 17, the inwardly-facing ramped surfaces 62 are inclined at approximately 30° to the central axis C. Returning then to FIG. 7, it will be appreciated that the outwardly-facing ramped surfaces 58 of the grippers are parallel with and in contact with the inwardly-facing ramped surfaces 52 of the collar 42.

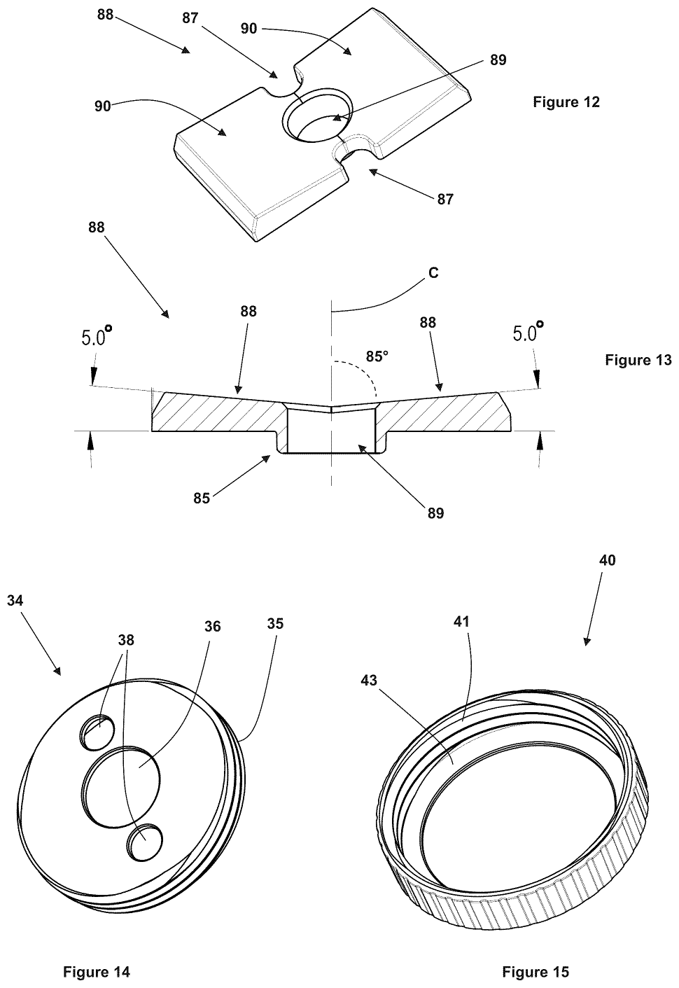

FIG. 7 also illustrates that the underside ramped surfaces 59 of the grippers 52 are parallel with and in contact with ramped surfaces 90 of the angle plate 88. Turning to FIGS. 12 and 13, the angle plate 88 is illustrated in isolation for convenience of description. The angle plate 88 is symmetrical about the central axis C and generally saddle shaped with a pair of ramped surfaces 90 angled at 85° with respect to the central axis. The pair of ramped surfaces 90 are angled from opposite sides of the central axis C such that the interior angle between the ramped surfaces is 170°. As shown in FIG. 12, the angle plate 88 includes a central opening 89 through which the pilot bit 12 extends and a pair of rounded bolt notches 87 through which bolts 39 extend. The angle plate 88 further includes a central rounded protuberance 85 on its underside and through which the central opening 89 extends.

Returning to FIG. 7, the angle plate 88 is seated on the mandrel body 70 which is illustrated in FIGS. 8 and 9 in isolation for convenience of description. The mandrel body 70 includes the drive shank 14, a cradle portion 95 including a pair of upstanding protrusions 71 orientated parallel with the central axis and including internally threaded bolt openings 73 on their top surfaces for engaging with the bolts 39.

The mandrel body 70 further includes a hollow stem 91 between the drive shank 14 and the cradle portion 95. The interior 97 of the hollow stem 91 is elongate and includes a hexagonal portion 101 (shown in FIG. 25) which corresponds and engages with the hexagonal base portion 102 (shown in FIG. 2) of the hex-shank pilot bit 12. In use, the hex-shank pilot bit 12 is correspondingly fitted within the hexagonal portion of the stem interior 97 such that rotation of the body 70 by a rotary power tool drives rotation of the pilot bit 12. The elongate stem interior 97 is aligned with the central axis C and with the pilot bit aperture 57 extending through the gripping arrangement 32. The elongate stem interior 57 and pilot bit aperture 57 are aligned with the central opening 89 in the angle plate 88. The pilot bit 12 therefore extends through each of the pilot bit aperture 57, the angle plate central opening 89 and the elongate stem interior 97. The mouth 96 of the stem interior 97 is located in the cradle portion 95 and (as best shown in FIG. 7) is provided with a countersink which receives the central rounded protuberance 85 on the underside of the angle plate 88. In this way, the angle plate 88 is securely seated in the cradle portion 95 with the protuberance 85 engaged with the countersunk mouth 96 of the elongate interior 97 of the stem 91.

The mandrel body 70 further includes a pair of blind holes 65 (only one of which is visible in FIG. 9) on opposite sides of the mouth 96. The holes 65 provide receptacles for debris which may enter the mechanism during use. For example, plaster dust which might accumulate inside the mechanism during repeated hole sawing of plaster sheeting.

Referring to FIG. 8, the stem 91 includes a ball opening 92 which extends from outside the stem 91 to the stem interior 97 into which the hex shank pilot bit 12 is received. The ball opening 92 has a slightly smaller diameter than the diameter of the ball 93 shown in FIGS. 5 and 7 such that the ball 93 can seat in the ball opening 92 with a portion of the ball 93 extending into the stem interior 97 and whilst preventing the ball 93 from passing completely through the ball opening 92 and falling into the stem interior 97. As was illustrated in FIG. 5, a flexibly resilient steel spring collar 94 is fitted around the stem 92 which retains the ball 93 in or against the ball opening 92.

As shown in FIG. 7, when the pilot bit 12 is fully inserted into the stem interior 97, the ball detent 13 in the pilot bit 12 is aligned with the ball opening 92 such that the portion of the ball 93 which extends into the stem interior becomes seated in the ball detent 13. Turning to FIG. 25, when the pilot bit 12 is withdrawn from the interior 97 of the stem 91, the ball 93 is urged out of the ball detent 13 through the ball opening 92 in a direction radially outward from the central axis C.

When the lock selector 44 is in the unlocked position, the ball 93 is permitted to move out of the stem interior 97 and into an unoccupied volume at the interior of the locking collar 44. When the locking collar 44 is at the locked position the ball 93 is prevented from moving radially outward and is retained in the ball detent 13 by an internal abutment of the locking collar 44.

Turning to 11, the locking collar 44 is illustrated in isolation for convenience of description. The locking collar 44 is comprises an annular wall 45 with a fluted exterior surface facilitating gripping by a user's fingers. The annular wall 45 includes an external indicating protrusion comprising a raised rib 46. An internal abutment comprising an internal radial protrusion 98 is located on the opposite side of the wall 45 from the raised rib 46. To the sides of the radial protrusion 98 there is an unoccupied volume 99 at the interior of the locking collar 44.

Returning to FIG. 7, the locking collar 44 is shown in the locked position corresponding to a locked mode in which the abutment 98 is aligned with the ball opening 92 so as to retain the ball in the ball detent 13 and thereby lock the pilot bit 12 against removal. In FIG. 25, the locking collar 44 is shown in the unlocked position corresponding to an unlocked mode and in which the abutment 98 is not aligned with the ball opening 92. In the unlocked mode, the ball 93 can therefore be urged out of the ball detent 13 through the ball opening 92 and into the unoccupied volume 99 within the locking collar 44 and thereby allowing the pilot bit 12 to be withdrawn from the stem interior 97.

The locking collar 44 surrounds a stem portion 77 of the base collar 76 which is best illustrated in FIG. 10. As previously noted, the underside of the base collar 76 includes locked indicia 48 and unlocked indicia 50. In the illustrated embodiment the indicia 48, 50 consist of the words ‘Lock’ and ‘Unlock’ respectively but it is to be appreciated that other indicia may be used such as a locked or unlocked symbol or pictographic.

A first notch 49 is adjacent to the locked indicia 48 and a second notch 51 is adjacent to the unlocked indicia 51. The notches 49, 51 provide visual indicators to which the user can align the raised rib 46. For example, the locking collar 44 may be turned to the first notch 49 adjacent the locked indicia 48 which indicates to the user that the locking collar 44 (and therefore the pilot bit connection arrangement) is in the locked mode.

The stem portion 77 of the base collar 76 includes a locking collar retention arrangement comprising a triangular rib 69 connected to the stem portion 77 via a flexibly resilient web 79 which permits resilient movement of the rib 69 in a radial direction with respect to the central axis C. The web 79 may therefore provide a plastic spring which is temporarily deformable and capable of resiliently returning to a normal position. The web 79 may be formed from a resilient polymer such as nylon or other suitable resilient material.

The rib 69 corresponds with a pair of triangular grooves 67a, 67b in the interior surface of the locking collar 44 and illustrated in FIG. 11. Each of the grooves 67a, 67b is associated with one of the locked and unlocked positions. With the locking collar in the locked position, the rib 69 is engaged with the groove 67b so as to retain the locking collar in that selected position. When rotated clockwise, the resilience of the web 79 is overcome and the rub 69 urged radially during rotation of the locking collar 44 and with the resilience of the web 79 urging the rib 69 radially outwardly against the interior of the locking collar. Once the locking collar 44 arrives at the unlocked position the rib 69 snaps into the triangular groove 67a so as to retain the locking collar in the unlocked position against inadvertent rotation.

The stem portion 77 further includes a circumferential slot 100 extending approximately 90° about the circumference of the stem portion 77. The slot includes a pair of opposite end faces 100a and 100b which are contacted by the internal radial protrusion 98 of the locking collar 44 when the locking collar is in either the locked or unlocked position. This prevents the locking collar 44 from 360° rotation about the central axis and limits rotation of the locking collar 44 to 90° of rotation between the locked and unlocked positions.

FIG. 22 illustrates the mandrel 10 fitted with a hole saw 118 having a relatively thick base 120. The thickness B1 of base 120 is labelled in FIG. 22. To accommodate use with the relatively thick base 120, the adjustable spacer 34 has been withdrawn into the spacer-adjustment collar 40 via manual rotation of the spacer-adjustment collar 40 which is in threaded engagement with the spacer 34. The spacer 34 is approximately flush with (or protrudes only very slightly beyond) the edge of the spacer-adjustment collar 40.

FIG. 23 illustrates the same mandrel 10 in use with a hole saw 18 having a thinner base than that of hole saw 118. The hole saw 18 has a base 20 of thickness B2 which is less than B1. To accommodate the thinner base 20, the adjustable spacer 34 has been selectively extended until contact with the underside 23 of the hole saw 18 and to press the base 20 against the gripper lips 54 in contact with the topside 21 of the base 20. In this manner, the hole saw base 20 is clamped between the gripper lips 54 and the adjustable spacer 34 providing a secure and stable connection during use of the mandrel 10 with a rotary tool.

It will therefore be appreciated that via operation of the spacer-adjustment collar 40, the mandrel 10 is securely connectable with hole saws of different base thickness and such that the mandrel 10 is compatible with a larger variety of hole saws.

FIG. 23 illustrates hole saw 18 detachably connected to the mandrel 10 and wherein the drive pins 30 are located within the drive pin apertures 28 and with the grippers 52 extended through the central mounting aperture 26. The grippers 52 are shown in the expanded configuration wherein the grippers 52 are spaced apart from another so that the expanded distance DE between an outer edge of the gripper lips 54 is larger than the diameter DA of the mounting aperture 26. In this configuration, the gripper lips overlap the topside 21 of the hole base 20 and thereby gripping the hole saw 18 against the mandrel 10. The grippers 52 are maintained in the normally expanded configuration under bias from the helical springs 86 (shown in FIG. 5) which urge the grippers 52 apart from one another.

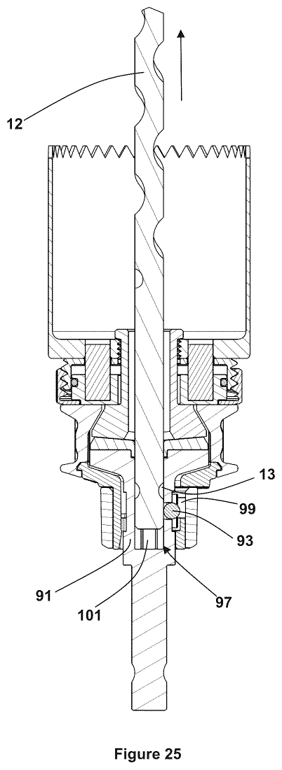

FIG. 24 illustrates the same componentry of FIG. 23 but with the gripping arrangement moved to the contracted configuration to allow disconnection and removal of hole saw 18 from mandrel 10. The sliding collar 42 has been manually slid along the central axis C in a downward direction (i.e. toward drive shank 14) and to the position shown in FIG. 23. The movement of sliding collar 42 has simultaneously shifted the base collar 76 along the central axis due to the connection between the base collar connection flanges 74 and the sliding collar grooves 72. The locking collar 44 is similarly shifted along the central axis by virtue of being fitted around the stem 77 of the base collar 76.

The movement of inwardly-facing ramp surfaces 62 apply a force onto the outwardly-facing ramp surfaces 58 of the grippers 52 which is normal to the plane of the ramp surfaces 62, 58 and which comprises a force component in the radially inward direction. This force overcomes the outwardly urging bias of the springs 86 causing the grippers 52 to move radially inward. This movement is guided and facilitated also by engagement between the underside ramped surfaces 59 of the grippers 52 and the angle plate ramped surfaces 90 which limit or prevents movement of the grippers in the direction of the central axis and directs movement of the grippers 52 radially inward.

The grippers 52 are thereby moved to the contracted configuration shown in FIG. 24 in which the grippers are brought into contact with one another and in which the contracted distance Dc between outer edges of the gripper lips 54 is approximately equal to or slightly less than the diameter DA of the central mounting aperture 26. The gripper lips 52 therefore no longer contact the topside 21 of the hole saw base 20 and the hole saw 18 is no longer secured to the mandrel 10 and can be manually removed by lifting the hole saw 18 off the drive pins 30.

Upon manual release of the sliding collar 42 the arrangement returns to the configuration shown in FIG. 23 under influence of the springs 86 which urge the grippers 52 apart and thereby draw the sliding collar 42 back along the central axis to its normal position which corresponds to the expanded configuration of the gripping arrangement 32.

Componentry of the mandrel 10 may formed from a variety of suitable materials. Components of the mandrel 10 subject to high load or contact with a hole saw (which are typically steel) may themselves be formed from steel. For example, the body 70, top plate 80 including drive pins 30 and the spacer 34 may be formed of a steel such as 40cr steel. Other components such as the sliding collar 42 and base collar 76 may be formed from a polymer such as nylon. The locking collar 44 may be formed of a thermoplastic such as acetal (Polyoxymethylene). Components such as the angle plate 88 and grippers 52 which are configured for repeated sliding movement against one another may be formed of a ferro nickel alloy. A person skilled in the art will appreciate that alternative suitable materials could be appropriate.

Those skilled in the art will appreciate that the invention described herein is susceptible to variations and modifications other than those specifically described. It is understood that the invention includes all such variations and modifications which fall within the spirit and scope of the present invention.

Where any or all of the terms “comprise”, “comprises”, “comprised” or “comprising” are used in this specification (including the claims) they are to be interpreted as specifying the presence of the stated features, integers, steps or components, but not precluding the presence of one or more other features, integers, steps or components.

1. A quick-change hole saw mandrel for a hole saw having a base with a central circular mounting aperture and a drive pin aperture, the mandrel including:
a drive shank extending along a central axis of the mandrel for releasable engagement with a rotary tool;
a mounting end opposite to the drive shank and configured for detachable connection with the mounting aperture of the hole saw and including a drive pin for engagement with the drive pin aperture of the hole saw;
a gripping arrangement disposed at the mounting end and insertable through the mounting aperture for gripping the hole saw base, the gripping arrangement having a normally expanded configuration in which the gripping arrangement grips the base against movement along the central axis and is selectively movable to a contracted configuration in which the gripping arrangement is insertable into or removable from the mounting aperture; and
a quick-release pilot bit connection arrangement for coupling a quick-release pilot bit to the mandrel, the connection arrangement configured for receiving the pilot bit through a pilot bit aperture extending centrally through the gripping arrangement and the pilot bit connection arrangement including a pilot bit lock selector for selecting between an unlocked mode permitting quick removal and quick insertion of the pilot bit and a locked mode in which the pilot bit is locked against removal from the pilot bit connection arrangement

2. A mandrel according to claim 1, wherein the lock selector comprises a locking collar rotatable about the central axis between an unlocked position corresponding to the unlocked mode and a locked position corresponding to the locked mode.

3. A mandrel according to claim 2, wherein the pilot bit connection arrangement is configured for use with a ball-detent hex shank pilot bit and includes a ball detent arrangement including a ball locatable in the ball detent of the hex shank for locking the shank against removal.

4. A mandrel according to claim 3, wherein the locking collar includes an internal abutment which, in the locked position, retains the ball in the ball detent of the hex shank.

5. A mandrel according to claim 1, further including an adjustable spacer disposed at the mounting end and configured to facilitate use of the mandrel with hole saws of different base thicknesses.

6. A mandrel according to claim 5, wherein the spacer is movable along the central axis relative to the gripping arrangement to accommodate various hole saw base thicknesses.

7. A mandrel according to claim 6, wherein the spacer is configured to contact an underside of the hole saw base and to clamp the hole saw base between the spacer and a portion of the gripping arrangement.

8. A mandrel according to claim 1, including a sliding collar manually movable along the central axis for selectively moving the gripping arrangement to the contracted configuration.

9. A mandrel according to claim 8, wherein movement of the sliding collar toward the drive shank actuates movement of the gripping arrangement to the contracted configuration.

10. A mandrel according to claims 8, wherein the gripping arrangement includes pair of grippers, each gripper including a distal end protruding from the mounting end and having a catch for engaging the base of the hole saw.

11. A mandrel according to claim 10, wherein the catch of each gripper is generally semi-circular and wherein, in the contracted configuration, the pair of catches forms an approximately circular configuration.

12. A mandrel according to claim 10, wherein the pair of catches is configured to contact a topside of the hole saw base and to clamp the hole saw base between the mounting end and the catches.

13. A mandrel according to claim 10, wherein the grippers of the pair of grippers are spaced apart from each other in the expanded configuration and moved toward each other in the contracted configuration.

14. A mandrel according to claim 13, wherein the grippers are movable in a direction perpendicular to the central axis.

15. A mandrel according to claim 10, wherein each gripper includes an outwardly-facing ramped surface in contact with an inwardly-facing corresponding ramped surface on the sliding collar and wherein movement of the inwardly-facing ramped surface of the sliding collar toward the drive shank urges the outwardly-facing ramped surfaces of the grippers toward the central axis and into the contracted configuration.

16. A mandrel according to claim 15, further comprising an angle plate having a pair of ramped surfaces in contact with corresponding ramped surfaces on an underside of the grippers and wherein contact between the ramped surfaces of the gripper undersides and the ramped surfaces of the angle plate promotes movement of the grippers toward the contracted configuration.

17. A mandrel according to claim 1, wherein the gripping arrangement includes a biasing arrangement urging the gripping arrangement toward the expanded configuration.

18. A mandrel according to claim 17, wherein the biasing arrangement includes including a pair of helical springs positioned between the pair of grippers.

19. A mandrel according to claim 1, further comprising a pair of drive pins configured for engagement with a pair of drive pin apertures in a hole saw, the pair of drive pins being located on opposite sides of the gripping arrangement.

20. A hole saw assembly, comprising:
a hole saw having a base and an annular wall extending from the base with a toothed cutting edge, the base including a central circular mounting aperture and at least one drive pin aperture;
a quick-release pilot bit comprising a ball-detent hex shank drill bit;
a quick change hole saw mandrel, including a drive shank extending along a central axis of the mandrel for releasable engagement with a rotary tool; a mounting end opposite to the drive shank detachably connected with the mounting aperture of the hole saw and including a drive pin in engagement with the drive pin aperture of the hole saw; a gripping arrangement at the mounting end which is inserted in the mounting aperture and gripping the hole saw base, the gripping arrangement having a normally expanded configuration in which the gripping arrangement grips the base against movement along the central axis and is selectively movable to a contracted configuration in which the gripping arrangement can be removed from the mounting aperture; and a quick-release pilot bit connection arrangement coupling the quick-release pilot bit to the mandrel, the pilot bit connection arrangement receiving the pilot bit through a pilot bit aperture extending centrally through the gripping arrangement and the pilot bit connection arrangement including a pilot bit lock selector for selecting between an unlocked mode permitting quick removal and quick insertion of the pilot bit and a locked mode in which the pilot bit is locked against removal from the connection arrangement
